(19) United States
(12) Patent Application Publication
(10) Pub. No.: US 2020/0217351 A1
(43) Pub. Date: Jul. 9, 2020

(54) WELDABLE CLINCH NUT

(71) Applicant: SCHAEFFLER TECHNOLOGIES AG & CO. KG, HERZOGENAURACH (DE)

(72) Inventor: Scott ANGEL, Akron, OH (US)

(73) Assignee: SCHAEFFLER TECHNOLOGIES AG & CO. KG, HERZOGENAURACH (DE)

(21) Appl. No.: 16/243,705

(22) Filed: Jan. 9, 2019

(51) Int. Cl. F16B 37/06; F16H 41/28

(52) U.S. Cl. CPC F16B 37/061; F16H 41/28

(57) ABSTRACT

A weldable clinch nut assembly. The assembly is configured to connect a flex plate to a cover of a torque converter. The assembly includes a base portion having a central portion, first and second lateral portions, and first and second connecting portions connecting the central portion to the first and second lateral portions, respectively. The central portion has an aperture. The assembly further includes a threaded nut fixed to the central portion and disposed between the first and second connecting portions. The first and second lateral portions include first and second projections, respectively. The first and second projections are configured to weld the weldable clinch nut assembly to the cover of the torque converter.

### TECHNICAL FIELD

The present disclosure relates to a weldable clinch nut for connecting a torque converter to a flex plate.

### BACKGROUND

A front wheel drive transmission envelope has relatively tight space constraints. For example, traditional drive plates may be relatively large and may occupy too much axial space to fit in a traditional front wheel drive transmission envelope. Reducing the axial profile of lugs that connect a torque converter and the flex plate may accommodate these relatively larger traditional drive plates.

### SUMMARY

According to one embodiment, a weldable clinch nut assembly is disclosed. The assembly is configured to connect a flex plate to a cover of a torque converter. The assembly includes a base portion having a central portion, first and second lateral portions, and first and second connecting portions connecting the central portion to the first and second lateral portions, respectively. The central portion has an aperture. The assembly further includes a threaded nut fixed to the central portion and disposed between the first and second connecting portions. The first and second lateral portions include first and second projections, respectively. The first and second projections are configured to weld the weldable clinch nut assembly to the cover of the torque converter.

According to another embodiment, a torque converter assembly for connecting a flex plate to the torque converter is disclosed. The assembly includes a cover plate and a weldable clinch nut assembly. The weldable clinch nut assembly includes a base portion having a central portion, first and second lateral portions, and first and second connecting portions connecting the central portion to the first and second lateral portions, respectively, the central portion having an aperture. The weldable clinch nut assembly also includes a threaded nut fixed to the central portion and disposed between the first and second connecting portions. The threaded nut has a threading. The first and second lateral portions include first and second projections, respectively. The first and second projections are configured to weld the weldable clinch nut assembly to the cover of the torque converter. The threading is configured to receive a fastener to connect the flex plate to the torque converter.

In yet another embodiment, a method of forming a weldable clinch nut assembly is disclosed. The method includes forming an aperture in a blank, forming first and second weld projections in the blank, fitting a threaded nut into the aperture, and bending the blank to form a base portion having a central portion, first and second lateral portions, and first and second connecting portions connecting the central portion to the first and second lateral portions, respectively. The central portion has the aperture and the first and second lateral portions have the first and second weld projections, respectively.

### BRIEF DESCRIPTION OF THE DRAWINGS

FIG. 1 is a top perspective view of a torque converter with nut assemblies according to an embodiment.

FIG. 2 is a section view of the torque converter with nuts taken along line 2-2 of FIG. 1.

FIG. 3 is a fragmented, top perspective view of one of the nuts shown in FIG. 1 isolated from the torque converter of FIG. 1.

FIG. 4 is a bottom perspective view of the nut shown in FIG. 3.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The term “substantially” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

A front wheel drive transmission envelope has relatively tight space constraints. Accordingly, it is an important design objective to limit the size of drive train components so that the components fit in the envelope. Non-limiting components of a drive train include a torque converter, a drive plate, and lugs or nuts that connect the torque converter and the flex plate. Size reductions of the lugs or nuts may be a design objective.

In one drive train design, a press fit clinch nut is directly riveted to an outer surface of a cover plate of a torque converter. A drive plate is then secured to the press fit clinch nut. This design may not fit within a front wheel drive transmission envelope. Accordingly, this design may not provide a solution for a front wheel drive transmission.

In another drive train design, a lug may be cold formed using rolling or pressing. The lug may be projection welded onto a cover plate of a torque converter. While cold formed, projection weldable lugs reduce the size occupied within a front wheel drive transmission envelope, such lugs may be too expensive for some applications.

In light of the foregoing, it would be desirable to provide a nut that meets the sizing constraints of a front wheel drive transmission envelope while meeting cost objectives. In one or more embodiments, weldable clinch nut assemblies are disclosed that achieves the sizing and cost objectives set forth above.

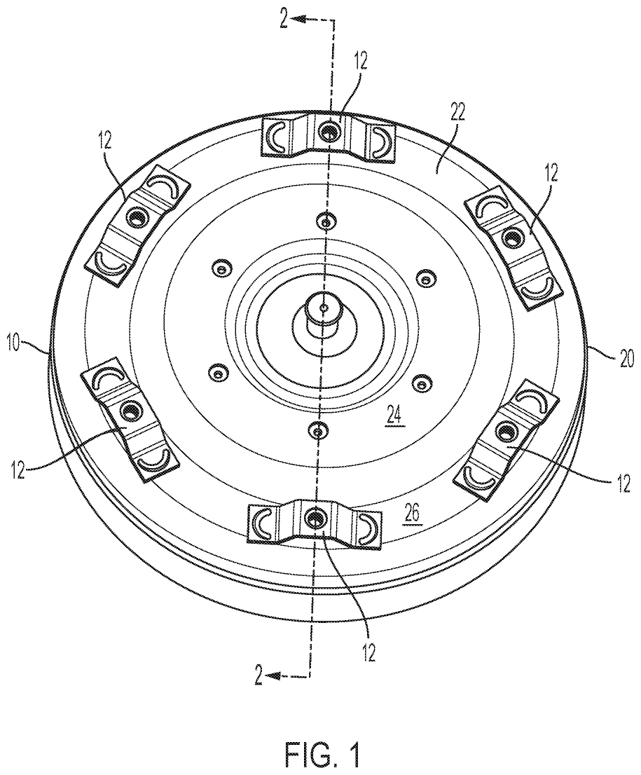

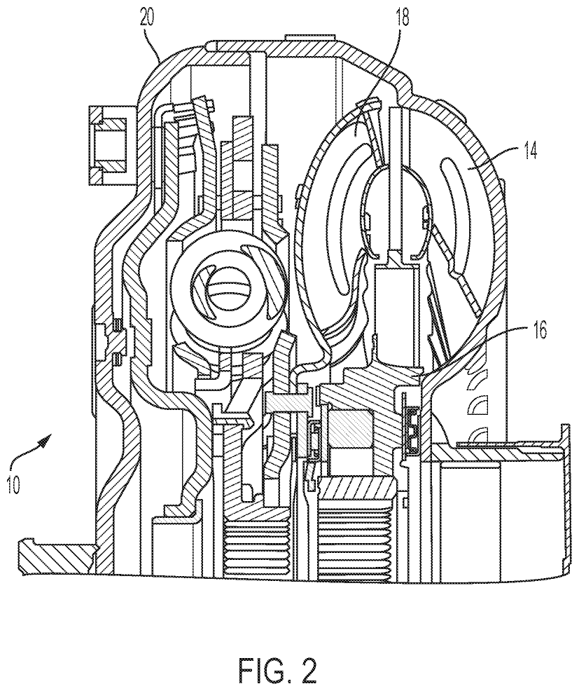

FIG. 1 depicts a top perspective view of torque converter 10 with nut assemblies 12 according to an embodiment. FIG. 2 depicts a fragmented, section view of torque converter 10 with nut assemblies 12 taken along line 2-2 of FIG. 1. Torque converter 10 includes impeller 14, stator 16, and turbine 18. Cover 20 is fixed to impeller 14 to form a housing for torque converter 10. Cover 20 may be fixed to impeller 14 using a welding process. Cover 20 includes outer surface 22, central portion 24 and peripheral portion 26 relative to a center plane of torque converter 10. As shown in FIG. 1, central portion 24 is raised relative to peripheral portion 26. Nut assemblies 12 are fixed to outer surface 22 of peripheral portion 26 of cover 20. In one embodiment, nut assemblies 12 are fixed using a welding process, such as a projection welding process. As shown in FIG. 1, six nut assemblies 12 are radially spaced apart from one each other on outer surface 22 of peripheral portion 26 of cover 20. In other embodiments, there may greater than or less than six nut assemblies 12. A flex plate (not shown) is secured to nut assemblies 12 so that the flex plate and torque converter 10 can mechanically communicate with each other.

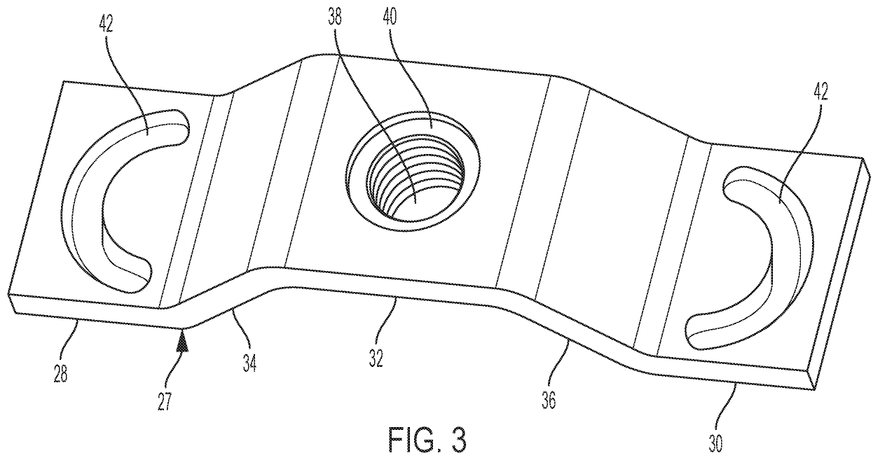

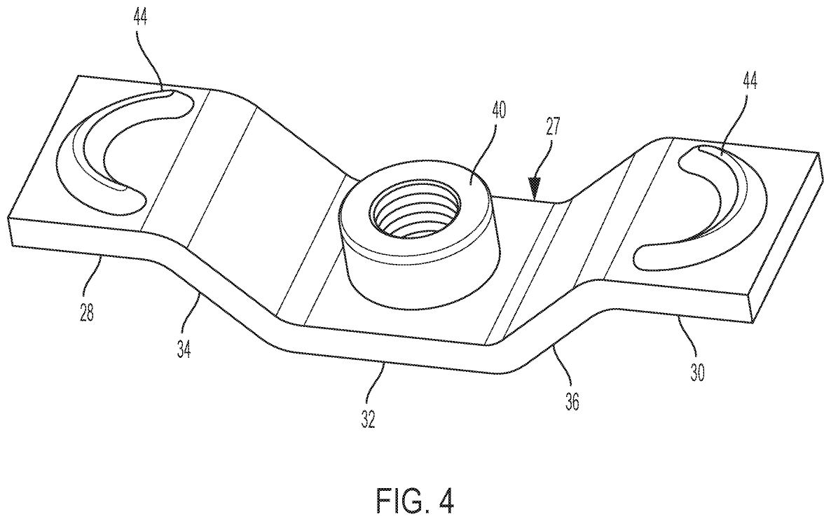

FIGS. 3 and 4 depict top and bottom perspective views of nut assembly 12 isolated from torque converter 10. Nut assembly 12 includes base portion 27 and threaded nut 40. Base portion 27 includes first and second lateral portions 28 and 30 and central portion 32. Base portion 27 also includes first and second angled portions 34 and 36. First lateral portion 28 and central portion 32 are bridged by first angled portion 34. Second lateral portion 30 and central portion 32 are bridged by second angled portion 36. Base portion 27 may be generally rectangular in shape such that the width of portions 28, 30, 32, 34 and 36 are equal or within ±1% of each other. The length of base portion 27 may be longer than the width. The thickness of portions 28, 30, 32, 34 and 36 may be equal or within ±1% of each other. First and second lateral portions 28 and 30 may have planar or flat top and/or bottom surfaces. First and second lateral portions 28 and 30 may be substantially planar to each other such that the angle of intersection between the top and/or bottom surfaces of first and second lateral portions 28 and 30 is within ±1% of each other. In other embodiments, the top and/or bottom surfaces of first and second lateral portions 28 and 30 are within the same plane(s). In certain embodiments, the top and/or bottom surfaces of (1) first and second lateral portions 28 and 30 and (2) central portion 32 are parallel to one another.

First and second angled portions 34 and 36 are at a first and second angle relative to central portion 32. The first and second angles may be the same angle. The first and second angles may be obtuse relative to central portion 32. In one embodiment, the first and second angles are independently selected from an angle in the range of 120 to 150 degrees.

Aperture 38 is formed in central portion 32 and receives threaded nut 40. Threaded nut 40 may be a threaded clinch nut press fit into aperture 38 of central portion 36. Threaded nut 40 extends into a space formed between first and second angled portions 34 and 36. Threaded nut 40 may be formed of a metal material. Threaded nut 40 may be formed of a different metal material than base portion 27. Threaded nut 40 is configured to receive a fastener configured to fasten a flex plate to threaded nut 40, thereby connecting the flex plate to torque converter 10.

Each of first and second lateral portions 28 and 30 includes channel 42 extending into body of portions 28 and 30 from the top surface of portions 28 and 30 and projection 44 projecting outward from the bottom surface of portions 28 and 30. In one or more embodiments, channel 42 and projection 44 are collectively referred to as a projection geometry. As shown in the Figures, the profile of the projection geometry is circular. In other embodiments, the projection geometry may be ovular, curved or linear. As shown in the Figures, each projection geometry has a circular curved portion and ends facing toward central portion 32, and the width of the circular curved portion is substantially constant.

A stamping process may be used to form base portion 27 from a rectangular blank. The blank may be cold formed by pressing or rolling steel to the desired thickness and then cutting the cold formed steel into the profile of the rectangular blank. Aperture 38 may be formed in the rectangular blank through a punching process or use of a shearing tool. The projection geometry may be formed in the rectangular blank by a stamping tool prior to forming base portion 27. In one embodiment, the result of the stamping process forms central portion 32 having aperture 38, first and second lateral portions 28 and 30, and first and second angled portions 34 and 36. Threaded nut 40 may be press fit into aperture 40 before or after the rectangular blank is formed into base portion 12.

Nut assembly 12 is placed on cover 20 with projections 44 facing outer surface 22 of cover 20. Nut assembly 12 is subsequently welded onto cover 20. In one embodiment, a projection welding process can be utilized. After projections 44 contact outer surface 22 of cover 20, then a current is applied to heat projections to a welding temperature. An electrode force causes the heated projections to collapse rapidly, fusing the heated projection to outer surface 22, thereby mechanically joining nut assemblies 12 to cover 20. As shown in the embodiment of FIG. 1, there is a gap between the lower end of threaded nut 40 and outer surface 22 configured to accommodate a lower portion of a fastener used to fasten the flex plate to nut assemblies 12.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Parts List

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

10 Torque Converter

12 Nut Assembly

14 Impeller

16 Stator

18 Turbine

20 Cover

22 Outer Surface

24 Central Portion

26 Peripheral Portion

27 Base Portion

28 First Lateral Portion

30 Second Lateral Portion

32 Central Portion

34 First Angled Portion

36 Second Angled Portion

38 Aperture

40 Threaded Nut

42 Channel

44 Projection

What is claimed is:

1. A weldable clinch nut assembly for connecting a flex plate to a cover of a torque converter, the assembly comprising:
a base portion having a central portion, first and second lateral portions, and first and second connecting portions connecting the central portion to the first and second lateral portions, respectively, the central portion having an aperture; and
a threaded nut fixed to the central portion and disposed between the first and second connecting portions,
the first and second lateral portions including first and second projections, respectively, the first and second projections configured to weld the weldable clinch nut assembly to the cover of the torque converter.

2. The weldable clinch nut assembly of claim 1, wherein the threaded nut includes a threading configured to receive a fastener to connect the flex plate to the torque converter.

3. The weldable clinch nut assembly of claim 1, wherein each of the first and second connecting portions taper away from the central portion toward the first and second lateral portions, respectively.

4. The weldable clinch nut assembly of claim 1, wherein the first and second projections have first and second profiles, the first and second profiles are curved.

5. The weldable clinch nut assembly of claim 1, wherein the first and second lateral portions occupy a first plane.

6. The weldable clinch nut assembly of claim 5, wherein the central portion occupies a second plane that is offset from the first plane and substantially parallel thereto.

7. The weldable clinch nut assembly of claim 6, wherein the first and second connecting portions are positioned between the first and second planes.

8. A torque converter assembly for connecting a flex plate to the torque converter, the assembly comprising:
a cover plate; and
a weldable clinch nut assembly comprising:
a base portion having a central portion, first and second lateral portions, and first and second connecting portions connecting the central portion to the first and second lateral portions, respectively, the central portion having an aperture; and
a threaded nut fixed to the central portion and disposed between the first and second connecting portions, the threaded nut having a threading,
the first and second lateral portions including first and second projections, respectively, the first and second projections configured to weld the weldable clinch nut assembly to the cover of the torque converter, the threading configured to receive a fastener to connect the flex plate to the torque converter.

9. The torque converter assembly of claim 8, wherein each of the first and second connecting portions taper away from the central portion toward the first and second lateral portions, respectively.

10. The weldable clinch nut assembly of claim 8, wherein the first and second projections have first and second curved profiles.

11. The weldable clinch nut assembly of claim 8, wherein the first and second projections project away from the central portion.

12. The weldable clinch nut assembly of claim 8, wherein the first and second lateral portions occupy a first plane.

13. The weldable clinch nut assembly of claim 12, wherein the central portion occupies a second plane that is offset from the first plane and substantially parallel thereto.

14. The weldable clinch nut assembly of claim 13, wherein the threaded nut does not contact the cover plate.

15. A method of forming a weldable clinch nut assembly, the method comprising:
forming an aperture in a blank;
forming first and second weld projections in the blank;
fitting a threaded nut into the aperture; and
bending the blank to form a base portion having a central portion, first and second lateral portions, and first and second connecting portions connecting the central portion to the first and second lateral portions, respectively,
the central portion having the aperture and the first and second lateral portions having the first and second weld projections, respectively.

16. The method of claim 15, wherein the second forming step includes stamping the first and second weld projections in the blank.

17. The method of claim 15, wherein the first and second forming steps occur prior to the bending step.

18. The method of claim 15, wherein the fitting step occurs prior to the bending step.

19. The method of claim 15, wherein the fitting step including press fitting the threaded nut into the aperture.

20. The method of claim 15, wherein the blank has a rectangular shape.
